(19) United States
(12) Patent Application Publication
(10) Pub. No.: US 2025/0373588 A1
(43) Pub. Date: Dec. 4, 2025

(54) DERIVATION OF A SECURE SESSION KEY IN RESOURCE CONSTRAINED ENVIRONMENTS

(71) Applicant: INTERNATIONAL BUSINESS MACHINES CORPORATION, ARMONK, NY (US)

(72) Inventors: Charles R. Johns, Austin, TX (US); Sandhya Koteshwara, White Plains, NY (US); Charanjit Singh Jutla, New York, NY (US); Nathan J. Manohar, White Plains, NY (US); Elaine R. Palmer, Hanover, NH (US); Guerney D. H. Hunt, Yorktown Heights, NY (US)

(21) Appl. No.: 18/678,776

(22) Filed: May 30, 2024

(51) Int. Cl. H04L 9/40; G06F 7/58

(52) U.S. Cl. CPC H04L 63/065; G06F 7/588

(57) ABSTRACT

A first entity generates a secure session key and an initialization vector for integrity protecting messages transmitted between the first entity and a second entity, wherein the secure session key is generated based on a first random number and a pre-shared secret, wherein the first random number is shared via a transmission by the first entity of a first random number message to the second entity, and wherein the first entity receives the pre-shared secret of the second entity during provisioning. The first entity transmits a second random number to the second entity to initiate a process for authenticating the second entity, wherein the second entity is resource constrained relative to the first entity and is not configurable to generate the second random number.

### BACKGROUND

Embodiments relate to a method, system, and computer program product for the derivation of a secure session key in resource constrained environments.

Many communication protocols provide a means for integrity protecting the transmission of data between two entities. In many situations, the transmitted data is also encrypted for confidentiality. Integrity protection and encryption may require a Session Key known only to the two entities that are communicating. Session keys are typically derived as part of establishing a Secure Communication Session between the two entities. One example of a protocol for establishing a Secure Communication Session is the Transport Layer Security (TLS) protocol, where TLS is an authentication and encryption protocol for Internet communications. In the TLS protocol, the two communicating entities exchange messages to acknowledge and authenticate each other, establish the cryptographic algorithms to be used, and derive one or more Secure Session keys.

TLS is a client-server protocol. The following is the basic flow for establishing a TLS session:
1. Client sends a message to the server which contains a random number known as the Client Random. This implies that the client contains or has access to a cryptographically secure random number generator.
2. After the server receives the Client Random message, the server sends a message to the client with the server's Secure Socket Layer (SSL) Certificates and a second random number known as the Server Random. This implies that the server contains or has access to a cryptographically secure random number generator.
3. After the client receives the Server Random message, the client verifies the Server's SSL Certificate with the Issuing Certificate Authority. This verifies that the server is authentic.
4. After authentication of the SSL Certificate by the client, a third random number is created by the client, encrypted using the Public Key of the server found in the SSL Certificate, and sent in a message to the server. This random number is known as the Premaster Secret.
5. When the server receives the Premaster Secret message, the server decrypts the message using the server's Private Key.
6. Both the client and server use the Client Random, Server Random, and Premaster Secret to derive the Secure Session Key(s).
7. Session is now established, and both entities are ready to send and receive secure messages.

As may be seen from the basic TLS protocol flow, both entities are required to contain cryptographically secure random number generators, Public/Private Key encryption, and at least one entity needs to have access to the Certificate Authority which issued the SSL Certificate.

### SUMMARY

Provided are a computer-implemented method, system, and computer program product in which a first entity generates a secure session key and an initialization vector for integrity protecting messages transmitted between the first entity and a second entity, wherein the secure session key is generated based on a first random number and a pre-shared secret, wherein the first random number is shared via a transmission by the first entity of a first random number message to the second entity, and wherein the first entity receives the pre-shared secret of the second entity during provisioning. The first entity transmits a second random number to the second entity to initiate a process for authenticating the second entity, wherein the second entity is resource constrained relative to the first entity and is not configurable to generate the second random number.

In additional embodiments, the first entity transmits a read message to the second entity, wherein the read message includes a request that the second entity return the second random number to the first entity. In yet additional embodiments, the first entity receives from the second entity, a second random number message that is integrity protected using a Machine Authentication Code (MAC) that is calculated using the secure session key and the initialization vector, wherein the second random number message contains the second random number.

In certain embodiments, the second entity is authenticated by the first entity via operations comprising: confirming a validity of the second random number message based on the MAC; and confirming that a number of the second random number message matches the second random number.

In further embodiments, the first entity is a Root-of-Trust (RoT) chiplet and the second entity is another chiplet in a System in a Package (SiP)), wherein the RoT has a capability to prevent the second entity from becoming operational.

In yet additional embodiments, the second entity has lower processing power in comparison to the first entity, wherein resources in the second entity are inadequate for executing a random number generator to generate the second random number.

In certain embodiments, the second entity has lower processing power in comparison to the first entity, wherein resources in the second entity are used for performing operations that do not include generation of the second random number via a random number generator.

In further embodiments, a third random number is used by the second entity to authenticate the first entity.

In certain embodiments, both the first entity and the second entity mutually authenticate each other, wherein the second random number and the third random number can be transmitted simultaneously, and wherein the third random number is integrity protected.

In additional embodiments, the mutual authentication is performed via: the third random number and a first MAC that allow the second entity to authenticate the first entity; and a second random number message and a second MAC that allow the first entity to authenticate the second entity.

### BRIEF DESCRIPTION OF THE DRAWINGS

Referring now to the drawings in which like reference numbers represent corresponding parts throughout:

FIG. 1 illustrates a block diagram of a computing environment, in accordance with certain embodiments.

FIG. 2 illustrates a table that shows certain definitions and symbols used in the description and the figures of certain embodiments.

FIG. 3 illustrates a table that shows information in a Team Roster provided to the Root-of-Trust (RoT) during provisioning of a System in Package (SiP), in accordance with certain embodiments.

FIG. 4 illustrates a block diagram that shows two flowcharts for integrity checking a message, in accordance with certain embodiments.

FIG. 5 illustrates a block diagram that shows two flowcharts that show operations for Data Verification processes used by the RoT and chiplet.

FIG. 6 illustrates a block diagram that shows first, second and third steps in a protocol used for authenticating the chiplets within the SiP, establishing the secure session, and derivation of the Secure Session Key (SKx) for each chiplet, in accordance with certain embodiments.

FIG. 7 illustrates a block diagram that shows fourth and fifth steps in a protocol used for authenticating the chiplets within the SiP, establishing the secure session, and derivation of the Secure Session Key (SKx) for each chiplet, in accordance with certain embodiments.

FIG. 8 illustrates a block diagram that shows the sixth step in a protocol used for authenticating the chiplets within the SiP, establishing the secure session, and derivation of the Secure Session Key (SKx) for each chiplet, in accordance with certain embodiments.

FIG. 9 illustrates a flowchart that shows exemplary operations for the derivation of a secure session key in resource constrained environments, in accordance with certain embodiments.

FIG. 10 illustrates a computing environment in which certain components may be implemented, in accordance with certain embodiments.

### DETAILED DESCRIPTION

In the following description, reference is made to the accompanying drawings which form a part hereof and which illustrate several embodiments. It is understood that other embodiments may be utilized, and structural and operational changes may be made.

Several examples will now be provided to further clarify various aspects of the present invention:
Example 1: A computer-implemented method in which a first entity generates a secure session key and an initialization vector for integrity protecting messages transmitted between the first entity and a second entity, wherein the secure session key is generated based on a first random number and a pre-shared secret, wherein the first random number is shared via a transmission by the first entity of a first random number message to the second entity, and wherein the first entity receives the pre-shared secret of the second entity during provisioning. The first entity transmits a second random number to the second entity to initiate a process for authenticating the second entity, wherein the second entity is resource constrained relative to the first entity and is not configurable to generate the second random number. As a result, derivation of a secure session key is performed in resource constrained environments in the computer-implemented method.
Example 2: The limitations of Example 1, where the first entity transmits a read message to the second entity, where the read message includes a request that the second entity return the second random number to the first entity. As a result, the first entity provides mechanisms to check whether the second entity is a malicious entity or whether insecure communication is taking place.
Example 3: The limitations of any of Examples 1-2, where the first entity receives from the second entity, a second random number message that is integrity protected using a Machine Authentication Code (MAC) that is calculated using the secure session key and the initialization vector. As a result, the resource constrained second entity does not have to generate a random number to securely communicate with the first entity.
Example 4: The limitations of any of Examples 1-3, where the second entity is authenticated by the first entity via operations comprising: confirming a validity of the second random number message based on the MAC; and confirming that a number of the second random number message matches the second random number. As a result, a determination is made by the first entity that the second entity is not a malicious entity.
Example 5: The limitations of any of Examples 1-4, where the first entity is a Root-of-Trust (RoT) chiplet and the second entity is another chiplet in a System in a Package (SiP)), where the RoT has a capability to prevent the second entity from becoming operational. As a result, the embodiments may be used for chiplets in a SiP.
Example 6: The limitations of any of Examples 1-5, where the second entity has lower processing power in comparison to the first entity, where resources in the second entity are inadequate for executing a random number generator to generate the second random number. As a result, the second entity can be a lightweight entity in comparison to the first entity.
Example 7: The limitations of any of Examples 1-6, where the second entity has lower processing power in comparison to the first entity, where resources in the second entity are used for performing operations that do not include generation of the second random number via a random number generator. As a result, the second entity does not have to spend processing time for generating random numbers for cryptographic operations.
Example 8: The limitations of any of Examples 1-7, where a third random number is used by the second entity to authenticate the first entity. As a result, the second entity is able to authenticate the first entity.
Example 9: The limitations of any of Examples 1-8, where both the first entity and the second entity mutually authenticate each other, wherein the second random number and the third random number can be transmitted simultaneously, and wherein the third random number is integrity protected. As a result, mutual authentication of two entities may be performed.
Example 10: The limitations of any of Examples 1-9, where the mutual authentication is performed via: the third random number and a first MAC that allow the second entity to authenticate the first entity; and a second random number message and a second MAC that allow the first entity to authenticate the second entity.

As a result, mutual authentication is performed via two random numbers.
Example 11: A system comprising a memory and a processor coupled to the memory, where the processor performs a computer-implemented method according to any of Examples 1-10. As a result, derivation of a secure session key is performed in resource constrained environments in the system.
Example 12: A computer program product comprising a computer readable storage medium having computer readable program code embodied therewith, where the computer readable program code when executed is configured to perform a method according to any of Examples 1-10. As a result, derivation of a secure session key is performed in resource constrained environments in the computer program product.

Systems are increasingly being designed using System-in-a-Package (SiP) technology. Chiplets may be combined on an interposer within a single package, where a chiplet is a small modular chip that may perform a special function extremely well. Communication links between these heterogeneous chiplets may form a communication fabric. Typically, one or more of these chiplets may act as a Root-of-Trust (RoT) for the system. Since chiplets and the interposer may be supplied by different manufacturers, they should not be trusted and there is a need for secure communication between chiplets and the RoT.

While the TLS protocol is acceptable for network communication, the TLS cryptographic requirements are too burdensome for chiplets communicating within a SiP. Therefore, there is a need for a lighter weight protocol for establishing a Secure Session that does not require computationally heavy cryptographic functions in both entities and is high-performance, in order to minimize the boot time for SiPs with many chiplets.

Additionally, with an increasing number of threats in computing environments ranging from supply chain security issues to insider threats, there is a need to protect the data between two entities, even when one of the entities may be severely restricted in its ability to perform cryptographic operations. While confidentiality of data may or may not be necessary, at a minimum, the authenticity and integrity of data must be protected while also preventing replay attacks. Mechanisms for integrity protecting (and encryption) between two entities are well understood. However, the establishment of the session usually requires cryptographic operations by each party. Thus, a method, system, and computer program product for the derivation of a Secure Session for integrity and replay protection of data in resource constrained (e.g., in terms of area and processing power) environments is required.

One example of such an environment is in the heterogeneous integration of chiplet based designs. Data flowing between two chiplets passes through an interposer and potentially through other chiplets, which are not trusted. Therefore, authentication and end-to-end integrity protection of data with protection against replay attacks is necessary to ensure the security of messages between chiplets, and in some instances, encryption for confidentiality may also be required. However, chiplets may be very simple and may sometimes not contain the necessary resources to perform cryptographic operations such as generation of random numbers, public/private key cryptography, etc. There is a need for both chiplets to mutually authenticate each other. Adding the necessary cryptographic functions for key derivation and mutual authentication to these simple chiplets would be a significant overhead and raise the cost and complexity of the system. The proposed method, system, and computer program product for the derivation of a Secure Session Key may be critical for improvements in a chiplet based design as well as any other resource constrained environments. Furthermore, adding storage and processing support for security functionality that meets the requirements of post-quantum cryptography may be prohibitive in resource-constrained environments. There is also a need for both chiplets to mutually authenticate each other.

As described above, authentication, integrity protection, prevention of replay, and potentially encryption of the transmission of data between two chiplets are requirements in many environments. While this is a well-established area, the creation of a secure session between the two entities typically requires each entity to perform cryptographic operations. However, having these cryptographic operations in every entity is an unacceptable overhead. Therefore, it is desirable to minimize the types of cryptographic operations needed for each entity and certain embodiments are directed towards such minimization.

In certain embodiments, each entity requires a Secure Session Key (SK), an Initialization Vector (IV), and a function for the generation and checking of a Hashed Based Message Authentication Code (HMAC). The HMAC is used to provide the integrity protection of data sent between two entities.

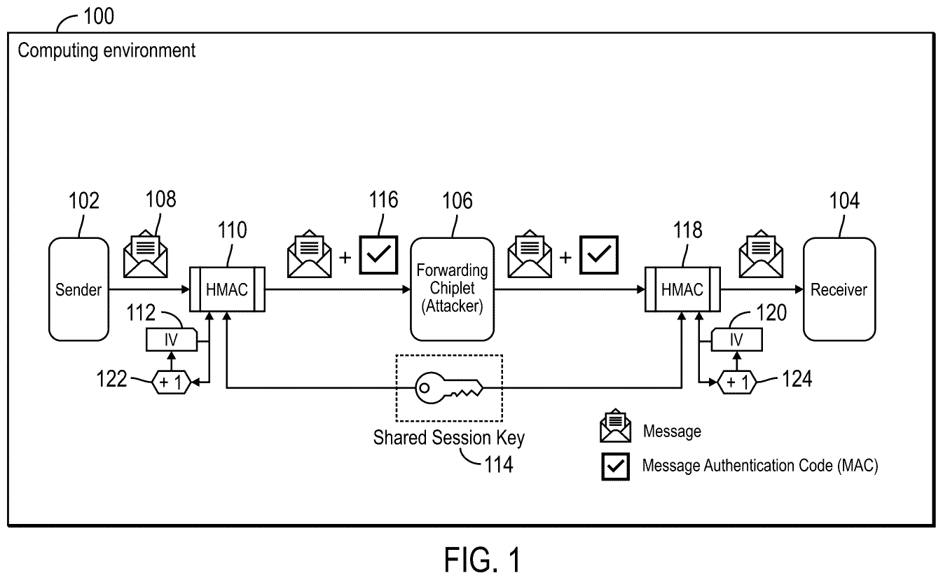

FIG. 1 illustrates a block diagram of a computing environment 100, in accordance with certain embodiments.

FIG. 1 shows the transmission of a message from a Sender chiplet 102 (referred also as sender) to a Receiver chiplet 104 (referred also as a receiver) with a forwarding chiplet 106 in the message path that may contain an attacker. The sender chiplet 102 and the receiver chiplet 104 may also be referred to as entities with the sender chiplet 102 being a first entity and the receiver chiplet 104 being a second entity. In certain embodiments, each entity requires a Secure Session Key (SK), an Initialization Vector (IV), and a function for the generation and checking of a Hashed Based Message Authentication Code (HMAC). The HMAC is used to provide the integrity protection of data sent between the two entities.

In certain embodiments, the sender creates the message 108 to be sent and uses a HMAC function 110, which takes the message 108, an Initialization Vector (IV) 112, and a secret shared session key 114 as input, to generate a Message Authentication Code (MAC) 116. The sender then generates an integrity protected message containing the original message and the generated MAC 116. The integrity protected message is then transmitted to the intended receiver. The receiver performs the same HMAC function 118 using the incoming message, the receiver's local Initialization Vector (IV) 120, and the secret shared session key 114 as input. The MAC generated by the receiver is then compared to the MAC received. If the two MAC values match, then the message is authentic and has not been altered or replayed by any attackers that may exist in the path. The IV value in both the sender and receiver are also incremented (reference numerals 122, 124) after every message is sent or received. Incrementing the IV is a critical operation to prevent replay of prior messages.

Before the sender or receiver can start sending integrity protected messages, a session must first be established. Part of establishing a session is the derivation of the Secret Shared Session Key. Typically, the derivation of the session key requires Public/Private key cryptography and random number generators in both the sender and receiver. This disclosure provides embodiments for the derivation of the session key that only requires a pre-shared secret and a random number generator in one of the entities. The pre-shared secret is known by the second entity and is shared with the first entity during provisioning. Once the session key is established then both entities can use the session key for transmitting and receiving messages but must maintain unique IVs for each direction. The protocol requires that the chiplet prevent a second session key negotiation, without reset, e. g., by using a flag.

In certain embodiments, the entity that contains the cryptographic functions is referred to as the Root-of-Trust (RoT) and the other entity is one of the other chiplets in the System-in-a-Package (SiP).

As explained earlier, a lighter weight method is needed for establishing a secure session and derivation of a Secure Session Key. Certain embodiments are specific to the heterogenous integration of chiplets in a SiP and more specifically to the communication between the SiP Root-of-Trust (RoT) and each chiplet. While described using the chiplet methodology, one skilled in the art can apply this method in other resource constrained environments.

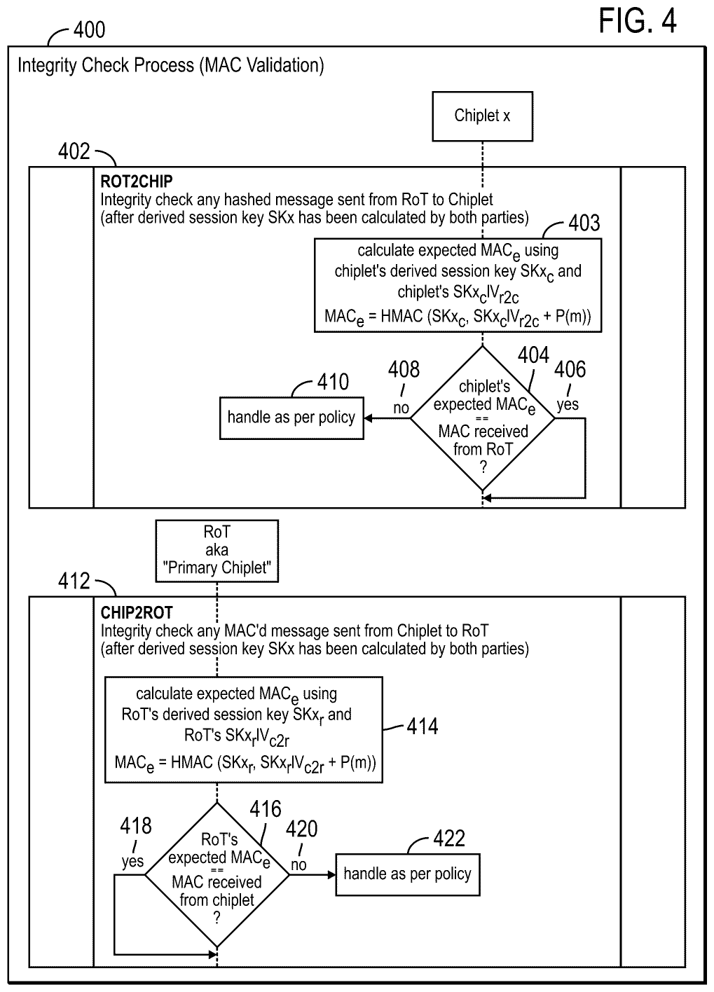

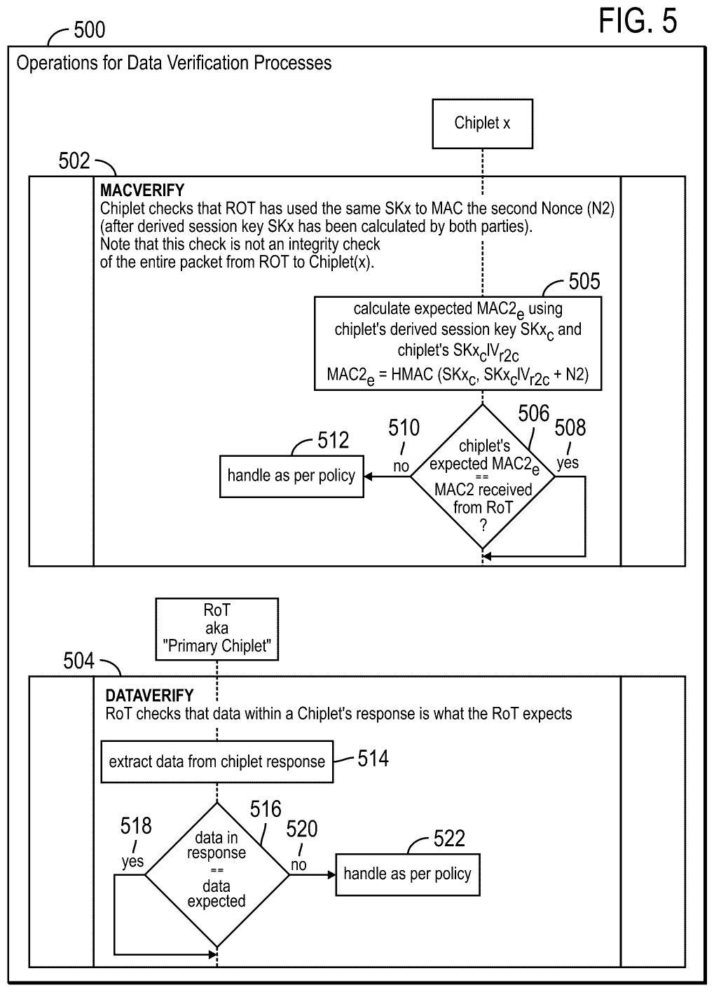

Below is an overview of the steps used for establishing the session key. It is important to note that we do not describe the error conditions in this overview. If an error occurs, such as those indicated in FIG. 4 and FIG. 5, the boot of the SiP terminates after taking the actions specified by the termination policy. Policy definition is well known in the art and very application dependent and therefore outside the scope of the embodiments of this invention. The steps are as follows:
0. An encrypted Team Roster is securely provided to the RoT during SiP provisioning. The Team Roster contains a unique chiplet secret (CKx) for each chiplet in the SiP.
1. The RoT creates a SKNonce (Secure Key Number used only once) and two Challenge Nonces (N1 and N2) using a cryptographically secure random number generator. The SKNonce must be non-deterministic whereas the N1 and N2 values can be pseudorandom or deterministic. (The same or a different SKNonce, N1, and N2 can be used for each chiplet in the SiP.)
2. The RoT forms a read request message for the chiplet's ID and sends the message to a target chiplet. The target chiplet returns the chiplet's ID in a read response message which is then verified with the expected value in the Team Roster by the RoT. The read message is not protected by a MAC. Also, Step 2 is not required for the derivation of the Secure Session Key but is usually performed by the RoT to get additional information and as a check to ensure the chiplet being targeted is the expected chiplet. Optionally, the chiplet may return additional information for derivation of the secure session key. This additional information should be unique to the session.
3. The RoT derives a secure Session Key (SKx) using the SKNonce and the Chiplet Secret (CKx). The secure session key is used for integrity checking messages between the RoT and the targeted chiplet. The IV for sending messages to the targeted chiplet (SKxIVr2c) and the IV for receiving messages from the targeted chiplet (SKxIVc2r) are also initialized to predetermined values. Next, the RoT calculates a MAC for the random Challenge N2 (MAC2), using SKx, and SKxIVr2c to prove the RoT knows the chiplet secret. After calculating MAC2, the RoT forms a write message for the SKNonce, the random Challenges (N1 and N2), and the calculated MAC2, and sends the message to the targeted chiplet. After sending the message, the RoT increments its version of the SKxIVr2c. The write message is not protected by a MAC. Furthermore, the derivation of the secure session key may also include additional pre-shared information in the Team Roster and the additional information returned by the chiplet in Step 2.

Also in this step, the targeted chiplet initializes their versions of the IVs to matching predetermined values.
4. Upon receiving the write message from the RoT, the targeted chiplet checks the flag to see if the secure session key has already been generated. If the flag is set the protocol terminates after taking an action specified by policy. If it has not been generated it derives a secure Session Key (SKx) using the SKNonce and the Chiplet Secret (CKx). If the secure session key has been generated it skips generation and continues on with the protocol. The secure session key is used for integrity checking messages between the RoT and the targeted chiplet. Next the chiplet verifies the integrity of the Challenge N2 using SKx, SKxIVr2, and the MAC2 received in the write message. After authentication of N2, the chiplet sets a flag which prevents any attempt to regenerate the secure session key during the session. The flag remains set until the session is terminated using a reset of the chiplet. The chiplet then increments its version of the SKxIVr2c. The derivation of the secure session key may also include additional pre-shared information in the Team Roster and the additional information returned by the chiplet in Step 2.
5. The RoT forms a read request message for the Challenge N1 written by the RoT in step 3 and received by the targeted chiplet in step 4. and sends the message to a target chiplet. Upon receiving the read request message, the targeted chiplet forms a read response message containing Challenge N1 and generates a MAC for the read response message using a HMAC function. The HMAC function uses SKx, derived in step 4, and the SKxIVc2r, initialized in step 3, concatenated with the Challenge N1. The targeted chiplet sends the read response message, with integrity (calculated MAC), to the RoT. Upon receiving the read response message, the RoT checks the integrity of the message using the SKx and SKxIVc2r. Both the RoT and the targeted chiplet increment their version of the SKxIVc2r. It may be noted that the read request message is not protected by a MAC.
6. After checking the integrity of the read response received in step 5, the RoT verifies the Challenge NI received in the read response matches the Challenge N1 written in step 3. If the values match, the chiplet is allowed into the system and the system is allowed to continue booting.

As explained earlier, a lighter weight method is needed for establishing a secure session and derivation of a Secure Session Key. Certain embodiments are specific to the heterogenous integration of chiplets in a SiP and more specifically to the communication between the SiP Root-of-Trust (RoT) and each chiplet. While described using the chiplet methodology, one skilled in the art can apply this method in other resource constrained environments.

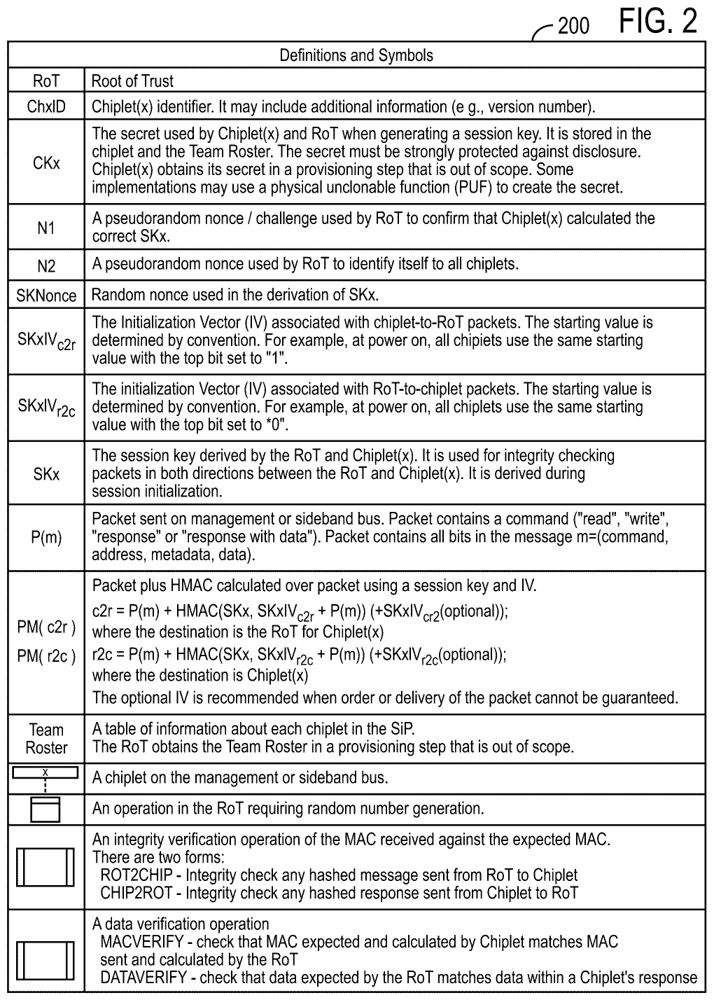

FIG. 2 illustrates a table 200 that shows certain definitions and symbols used in the description and the figures of certain embodiments.

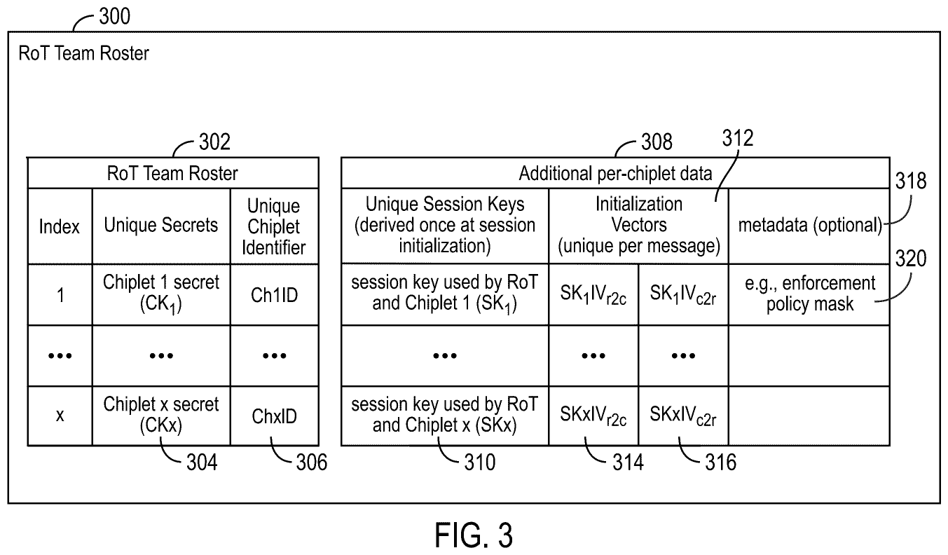

FIG. 3 illustrates a table 300 that shows information in a Team Roster provided to the Root-of-Trust (RoT) during provisioning of a System on a Package (SiP), in accordance with certain embodiments.

The Team Roster 302 provided to the RoT (also referred to as RoT Team Roster) contains a Chiplet Secret (CKx) 304 and a Unique Chiplet Identifier (ChxID) 306 for each chiplet in the SiP. The Team Roster is not limited to this information and may contain additional information 308 specific to each chiplet, such as a serial number, version number, manufacturer's ID, optional metadata 318 including enforcement policy mask 320, etc. The information is collected from the chiplets or directly from the manufacturer during the manufacturing of the SiP. The information is encrypted using a key specific to the SiP RoT. The encrypted data is then provided to the RoT when the SiP is provisioned. There are many different methods for providing the information, such as programmed into an internal ROM, programmed into an external EPROM, and then read by the RoT during Power-on, etc.

The Chiplet Secret (CKx) must be strongly protected against disclosure. Therefore, in certain embodiments, the chiplets use a physically unclonable function (PUF) to create the CKx value. The PUF must create the same value at every power-on of the chiplet. Furthermore, CKx must be encrypted with a key known only by the RoT.

The Team Roster 302 is further augmented with additional information 308 about each chiplet during the establishment of the Secure Session and potentially other steps in the SiP Boot process. Specific to certain embodiments, the Team Roster information is augmented with the Secure Session Key (SKx) 310 and the Initialization vectors 312 for sending and receiving messages between the associated chiplet and the RoT (SKxIVc2r 314 and SKxIVr2c 316 respectively).

Certain embodiments rely on the RoT's ability to allow chiplets into the system and to continue booting to prevent a device in the middle attack that pretends to be the RoT. This is referred to as “Security with Abort.” This allows the protocol to achieve “forward security”. Forward security implies that no malicious chiplet can pretend to be the RoT to a good chiplet even when given access to old session keys of a good chiplet, for example through leaked logs. If the resource constrained environment does not meet this condition, a second RoT secret can be pre-shared in a similar manner as the Team Roster with each chiplet. The second RoT secret must be unique to each chiplet and is used by the chiplet to authenticate the RoT.

FIG. 4 illustrates a block diagram 400 that shows two flowcharts for integrity checking a message, in accordance with certain embodiments. The integrity checking may include MAC validation.

The first flowchart 402 shows a process referred to as a ROT2CHIP process. In this process, a chiplet calculates (at block 403) the expected MACe using a cryptographic HMAC function with the derived session key (SKx), and the SKxIVr2c plus the received message P(m). The calculated MACe is then compared (at block 404) to the MAC received as part of the message PM(r2c) [as shown via reference numeral 404]. If the two MAC values match (“yes” branch 406), the protocol continues to the next step [as shown via reference numerals 404, 406]. If the two values do not match (“no” branch 408), the error is handled (at block 410) per the policy selected [as shown via reference numerals 404, 408, 410]. The policy is either hard coded or selected as indicated in the enforcement policy mask 320.

The second flowchart 412 shows a process referred to as a CHIP2ROT process. In this process, a RoT calculates (at block 414) the expected MACe using a cryptographic HMAC function with the derived session key (SKx), and the SKxIVc2r plus the received message P(m). The calculated MACe is then compared (at block 416) to the MAC received as part of the message PM(c2r) [as shown via reference numeral 416]. If the two MAC values match (“Yes” branch 418), the protocol continues to the next step [as shown via reference numerals 416, 418]. If the two values do not match (“No” branch 420), the error is handled (at block 422) per the policy selected [as shown via reference numerals 416, 420, 422]. The policy is either hard coded or selected as indicated in the enforcement policy mask 320.

FIG. 5 illustrates a block diagram 500 that shows two flowcharts 502, 504 that show operations for Data Verification processes used by the RoT and chiplet.

The first flowchart 502 shows a process referred to as a MACVERIFY process. The MACVERIFY process is used by the chiplet to verify the MAC2 of the Challenge N2. In the first step 505, the chiplet calculates the expected MAC2e using a cryptographic HMAC function with the derived session key (SKx), and the SKxIVr2c plus the received Challenge N2. If the expected MAC2e matches the Challenge N2 MAC2 received from the RoT (“yes” branch 508), then the protocol continues to the next step [as shown via reference numerals 506, 508]. If the expected MAC2e does not match the Challenge N2 MAC2 (“no” branch 510), the error is handled per the policy selected [as shown via reference numerals 506, 510, 512]. The policy is either hard coded or selected as indicated in the enforcement policy mask 320.

The second flowchart 504 shows a process referred to as a DATAVERIFY process. The DATAVERIFY process is used by the RoT to validate data received from the chiplet. The first step 514 is for the RoT to extract the data from the chiplet's read response message P(m). The extracted data is then compared (at block 516) to the data expected by the RoT. If the extracted data matches the expected data (“yes” branch 518), then the protocol continues to the next step. If the extracted data does not match the expected data (“no” branch 520), the error is handled (at block 522) per the policy selected [as shown via reference numerals 566, 520, 522]. The policy is either hard coded or selected as indicated in the enforcement policy mask 320.

While the MACVERIFY process is shown to only be used by the chiplet and DATAVERIFY process is shown to only be used by the RoT, the RoT and chiplet can utilize similar processes (MACVERIFY and DATAVERIFY respectively) for authentication of MAC received from the chiplet and authentication of data received from the RoT.

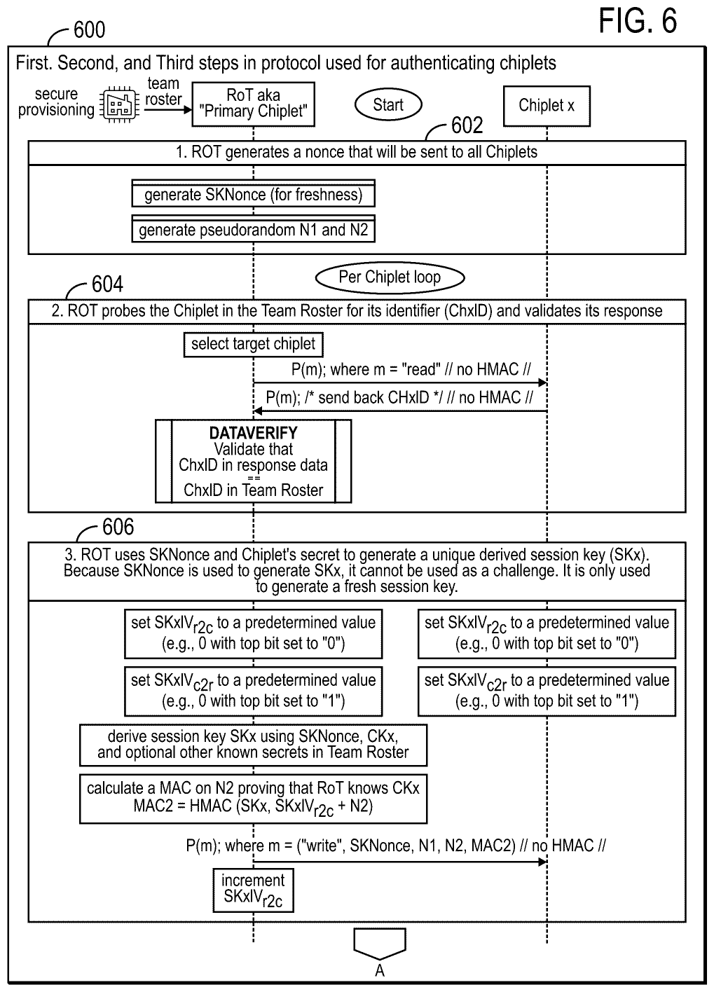

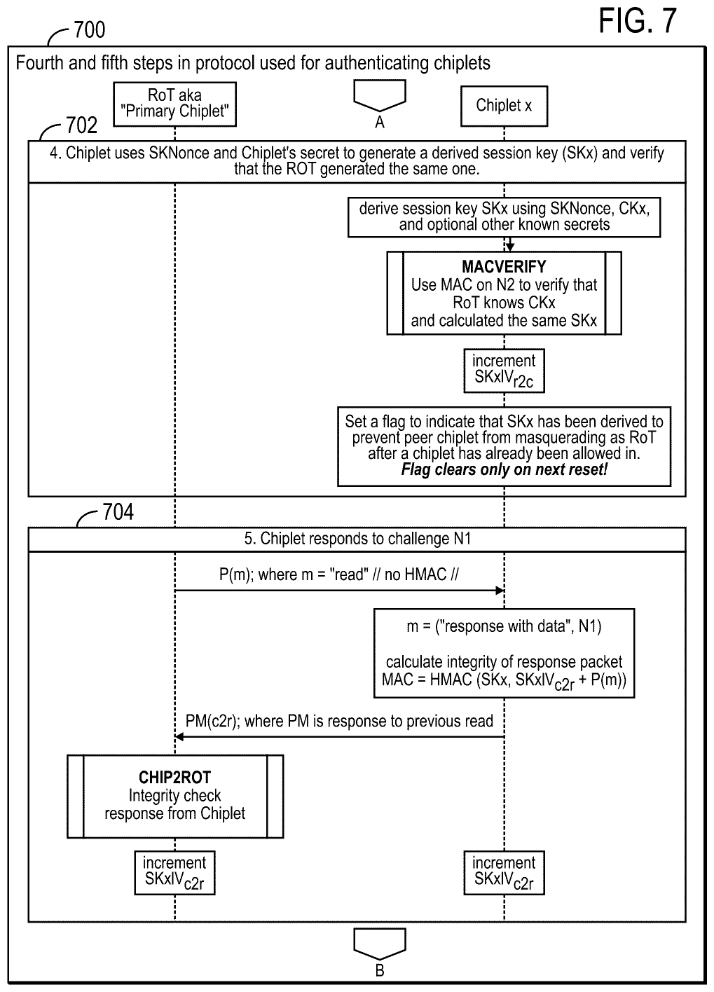

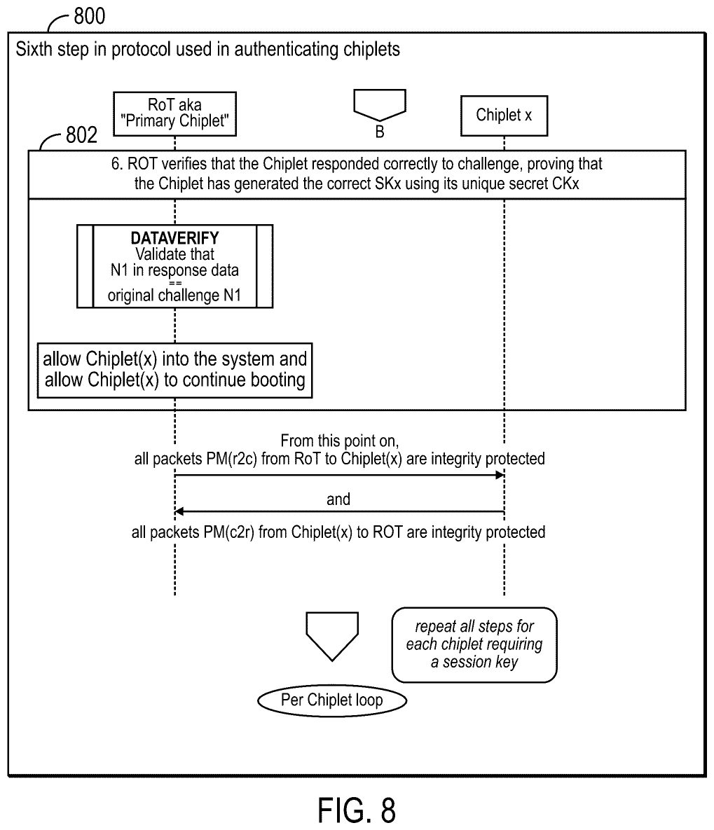

FIGS. 6, 7, and 8 outline the protocol used for authenticating the chiplets within the SiP, establishing the secure session, and derivation of the Secure Session Key (SKx) for each chiplet. The processes defined in FIG. 4 and FIG. 5 are used at various points in the protocol. The first, second, and third steps of the protocol are shown in FIG. 6. The fourth and fifth steps of the protocol are shown in FIG. 7, and the sixth step of the protocol is shown in FIG. 8. The first, second, third, fourth, fifth, and sixth steps shown in FIGS. 6, 7, 8 are performed in sequence.

FIG. 6 shows in a block diagram 600 the first three steps of the protocol. Prior to the first step 602, the Team Roster 302 is provided to the RoT when the SiP is provisioned as shown in FIG. 3. After the information in the Team Roster has been retrieved or provisioned, the RoT generates at the first step 602 a Random Number and two random Challenges, referred to as the SKNonce, N1, and N2 respectively, using a cryptographically secure random number generator. The SKNonce must be non-deterministic whereas the N1 and N2 values can be pseudorandom or deterministic. The Random Number generator should be FIPS certified (or equivalent). The SKNonce is used in the derivation of the Secure Session Key. As shown in FIG. 6, FIG. 7, and FIG. 8, a single value for SKNonce, N1, and N2 may be used for all chiplets in the SiP. However, it is also acceptable to generate different values for SKNonce, N1 and N2 for each chiplet or subset of chiplets. After generation of the SKNonce, N1 and N2 the RoT performs the second and third steps (shown in FIG. 6), the fourth and fifth step (shown in FIG. 7) and the sixth step (shown in FIG. 8), for each chiplet in the SiP.

In the second step 604, the RoT selects a target chiplet and forms a read request message, P(m) where m is a “read” command, to read the chiplet ID (CHxID; where x is the chiplet number). The ChxID is typically located at a specific address defined by the bus architecture (e.g., UCIe Management Bus). This message is then sent to the selected chiplet and is not protected using a Message Authentication Code (MAC). In response to receiving the chiplet ID read request, the chiplet forms a read response message, P(m) where m is a “read-response” command with the chiplet ID as the data, and sends the message to the RoT. The read-response is also not protected using a MAC. When the RoT receives the read-response from the chiplet, the data authentication process defined in FIG. 5 is performed using the expected chiplet ID as defined in the Team Roster. Typically, the RoT will wait for a predetermined amount of time for the read-response. If the response has not been received in the predetermined time, a time-out error handler (not shown) is invoked, and the error is handled per policy. If the expected chiplet ID is received, then the protocol continues to the third step.

Along with the chiplet ID, additional information may be returned by the chiplet in read response. This additional information along with other additional pre-shared information in the Team Roster is used in the derivation of the Secure Session Key. For improved security, the additional information should be unique to each session (or power-on/reset cycle).

The third step 606 performs the derivation of the Secure Session Key. In the third step 606, the RoT sets its copy of the SKxIVr2c and SKxIVc2r initialization vectors to a predetermined value and the chiplets sets its copy of the SKxIVr2c and SKxIVc2r to a predetermined value. The RoT and the chiplets it is communication with must use the same pre-determined value for SKxIVr2c and SKxIVc2r. However, each of the chiplets does not have to use the same value as other chiplets in the SiP at this step. The predetermined values must be assigned such that the same secure session key/IV value pair is never reused for sending or receiving messages during the entire session. (e.g., Setting the upper bit to ‘0’ for the SKxIVr2c and the upper bit to ‘1’ for the SKxIVc2r). While certain embodiments have different IVs for messages in each direction, one skilled in the art can see how a single IV can be used as long as both entities ensure that the same SKx and IV value pair is never used twice in one session. As shown, the chiplets also sets its copy of the SKxIVr2c and SKxIVr2r to a matching predetermined value (however, the chiplets can perform this operation any time prior to using the SKxIVr2c and SKxIVc2r ).

Next, the RoT derives a Secure Session Key (SKx) using the SKNonce and the chiplet secret, and optionally other chiplet information that was shared with the RoT via the Team Roster or with the read of the chiplet ID. Next, the RoT calculates a MAC (MAC2) using a cryptographic HMAC function with the derived SKx and SKxIVr2c concatenated with the Challenge N2 as input. After the MAC2 is calculated, the RoT forms a write message, P(m) where m is a “write” command and the data is the

SKNonce, Challenge N1, Challenge N2, and the calculated MAC2. This message is then sent to the selected chiplet and is not protected using a MAC. After sending the message, the RoT increments its local copy of SKxIVr2c .

In certain embodiments, an SHA-3 secure hash algorithm is used for the derivation of the Session Key. However, other secure hash functions are acceptable such as SHA-2 or AES, and their variants.

FIG. 7 shows in a block diagram 700 that shows the fourth and fifth steps of the protocol. In the fourth step 702 after receiving the write message, the chiplet checks to see if the key has already been derived, and if it has, it skips the derivation step. If it has not been derived it derives a Secure Session Key (SKx) using the SKNonce and the chiplet secret and optionally other secret chiplet information that was shared with the RoT via the Team Roster or read of the chiplet ID. The Secure Session Key will not be derived if the key already exists for session (not shown in FIG. 7 for brevity). This is accomplished by setting a flag when a Session Key is first generated and only clearing the flag when the chiplet is reset. The flag prevents regeneration of the Secure key. After the SKx is derived, the chiplet verifies the Challenge N2. This is done by calculating a MAC2e using the same cryptographic HMAC function with the derived SKx and SKxIVr2c concatenated with the received Challenge N2 as input (As shown in FIG. 5).

The chiplet then increments its version of the SKxIVr2c and sets a flag to indicate the Secure Session Key has been generated for this session and will prevent any future attempts to generate a new Secure Session Key. This flag will only reset on a power cycle or other full reset that removes all secure information.

Continuing with the fifth step 704, the RoT forms a read message (P(m), where m is a “read” command) to retrieve the random Challenge N1 written is the third step from the selected chiplet. The message is then sent to the selected chiplet. This message is not integrity protected.

Once the selected chiplet receives a read message, P(m), the chiplet forms a read-response message, P(m) where m is a “read-response” command with the random Challenge (N1) received in the third step as the data. A MAC is then calculated for the read response message P(m) using a cryptographic hash such as an HMAC. The calculation uses the SKx derived in fourth step and the SKxIVc2r, initialized in the third step, concatenated with the read response message P(m). The read response message P(m) concatenated with the calculated HMAC, referred to as PM (c2r ), is then sent back to the RoT. After sending the message, the chiplet increments its local copy of SKxIVc2r .

Once the RoT receives a read response message, PM (c2r ), the integrity of the message is checked using the CHIP2ROT process outlined in FIG. 4. The RoT increments its local copy of SKxIVc2r. If the validation fails, the RoT handles the error per an identified policy. If the validation process is OK, the RoT proceeds to the next step.

FIG. 8 shows a block diagram 800 that includes the sixth step in the protocol. In the sixth step 802, the random challenge is extracted from the read-response message received and integrity checked in the fifth step. The extracted random challenge is then compared with the random challenge (Nx) sent in the fourth step using the data authentication process defined in FIG. 5. The RoT increments its local copy of SKxIVc2r. If the authentication fails, the RoT handles the error per an identified policy. If the authentication passes, the RoT does not proceed to the next step. The chiplet is allowed into the system.

Since the RoT was able to integrity check the read-response in the fifth step and validate the random challenge received correctly by the chiplet in the fourth step, both the RoT and the chiplet are known to have derived the same Secure Session key and initialized the initialization vectors, SKxIVr2c and SKxIVc2r, correctly. The RoT then allows the chiplet into the system and to continue booting. If any of the steps fail, the error is handled per policy and the RoT will not allow the chiplet into the system or to continue to boot. Since the chiplet was able to validate the MAC2 for N2, the chiplet has authenticated the RoT once it is allowed to continue to boot. Similar operations take place for the RoT authenticating the chiplet if N1 is validated.

From this point on and until a reset of the chiplet is performed, all messages between the RoT and the chiplet are protected using a HMAC generated using the derived SKx and the current SKxIVr2c concatenated with the message P(m), and all messages between the chiplet and the RoT are protected using a HMAC generated using the derived SKx and the current SKxIVr2r concatenated with the message P(m). After every message is sent or received, the corresponding SKxIV is incremented. The initialization vector must be long enough to never repeat during the entire session, or an addition secure protocol must be used to derive a new Session Key, and this is well known in the art.

Finally, the RoT will repeat the second through sixth steps for all chiplets in the SiP.

The above figures show a provably secure method for generating a Secure Session

key between two entities and authenticating each other. Furthermore, the method only requires one of the entities to contain a cryptographically secure, FIPS-certified, random number generator.

In certain embodiments, the hardware requirements are as follows:
(1) The RoT is required to contain a cryptographically strong, FIPS-certified, random number generator, a method for obtaining or storing a team roster containing all the identities and secrets of the chiplets, key derivation hardware, storage for the derived secure session keys and two initialization vectors for each chiplet, and the hardware for generation and checking of the HMAC for integrity checking messages between the RoT and each chiplet. The RoT is required to prevent chiplets from becoming operational until the chiplet has been authenticated.
(2) The chiplet is required to contains a chiplet identifier identity, a chiplet secret (preferably created by a PUF), key derivation hardware, storage for one Nonce, storage for the derived secure session keys and two initialization vectors, and the hardware for generation and checking of the HMAC for integrity checking messages between the RoT and each chiplet, and storage for a flag indicating whether the secure session key has been derived.
(3) RoT must have the ability to enable individual chiplet or prevent a chiplet or the SiP from booting if a chiplet is not authenticated. Chiplets must not have the ability to enable other chiplets. As an example, the RoT can hold the operational portion of each chiplet in reset until the chiplet has been authenticated using the protocol illustrated in FIGS. 6, 7 and 8 performed over a management interface.
(4) Reliable communication path between RoT and Chiplets.

In certain embodiments, the Chiplet must only perform the secure session key derivation once per session. The chiplet must be reset before a new session can be established. Using well understood protocols, a session key may be updated (or roll from an old key to a new key) at specified intervals.

Certain embodiments establish a way for chiplets to integrity check data from SiP RoT without having to trust the interposer or intermediate chiplets. Certain embodiments do not depend on modification of access level by intermediate chiplets. No RNG is required on chiplets, and no public key cryptography is required. Post-quantum cryptography resistant solutions are provided by certain embodiments.

Various threat models are discussed below.

If the malicious intent chiplet tricks other chiplets to think the malicious chiplet is RoT by being the first to authenticate with chiplets (first-come-first-served) then the real RoT will catch this eventually and prevent the chiplet and/or system from continuing to boot, because the tricked chiplets will not have the real RoT's nonce. Also, the tricked chiplet will not negotiate a second key.

If the malicious chiplet acts as attacker-in-the-middle then the malicious chiplet accepts Nonce from real RoT, then fakes another Nonce to endpoint chiplet. However, the attacker-in-the-middle does not have the team roster. The real RoT will catch this eventually and prevent the chiplet and/or system from continuing to boot, because the tricked chiplets will have the real RoT's Nonce and the derived secure session keys will not match.

If there is an isolated connection between a legitimate and a malicious chipset then until the real RoT and chiplet authenticate each other, a legitimate chiplet could be tricked into establishing a session with an evil chiplet, thinking the malicious chiplet is the RoT. Then, they have their own isolated private connection. One defense against this in certain embodiments is that the real RoT must probe each chiplet in its team roster, then take action (e.g., shut down the entire SiP) if one of the chiplets does not respond appropriately. This defense assumes that the real RoT becomes operational first. A second defense is that the SiP cannot join a larger system until it has been authenticated and its attestation verified.

If there is an isolated connection between two evil chiplets then the isolated connection could be used to establish a covert channel, where one leaks information to another who gets it out of the SiP. In certain embodiments, if the chiplets are not in the team roster, then they are not allowed to boot.

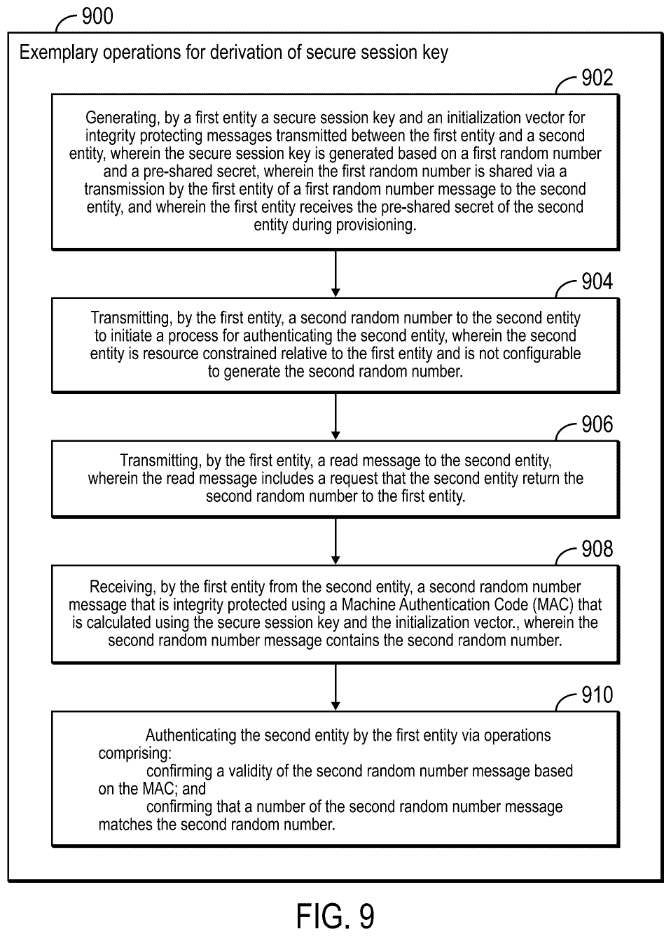

FIG. 9 illustrates a flowchart 900 that shows exemplary operations for the derivation of a secure session key in resource constrained environments, in accordance with certain embodiments.

Control starts at block 902 in which a first entity generates a secure session key and an initialization vector for integrity protecting messages transmitted between the first entity and a second entity, wherein the secure session key is generated based on a first random number and a pre-shared secret, wherein the first random number is shared via a transmission by the first entity of a first random number message to the second entity, and wherein the first entity receives the pre-shared secret of the second entity during provisioning. The first entity transmits (at block 904) a second random number to the second entity to initiate a process for authenticating the second entity, wherein the second entity is resource constrained relative to the first entity and is not configurable to generate the second random number.

From block 904 control proceeds to block 906 in which the first entity transmits a read message to the second entity, wherein the read message includes a request that the second entity return the second random number to the first entity.

From block 904 control proceeds to block 906 in which the first entity receives from the second entity, a second random number message that is integrity protected using a Machine Authentication Code (MAC) that is calculated using the secure session key and the initialization vector, wherein the second random number message contains the second random number.

Control then proceeds to block 908 in which the second entity is authenticated by the first entity via operations comprising: confirming a validity of the second random number message based on the MAC; and confirming that a number of the second random number message matches the second random number.

In yet further embodiments, the first entity is a Root-of-Trust (RoT) chiplet that is the sender 102 and the second entity is another chiplet that is a receiver 104 in a System in a Package (SiP).

Therefore, FIGS. 1-9 illustrate embodiments for the derivation of a secure session key in resource constrained environments.

Certain embodiments provide mechanisms for deriving a Secure Session Key between two entities where:
0. A first entity is provided, in a secure manner, with a pre-shared secret(s) and the ID contained in a second entity.
1. The first said entity generates a first random number, a second, and a third random number.
2. The first entity generates a read message requesting the chiplet ID. Upon receipt of the read message, the second entity generates a read response containing the chiplet's ID. Upon receipt of the read response message, the first entity verifies chiplet's ID with the value shared in Step 0. If the chiplet's ID matches, the process continues with the next step. If the chiplet's ID does not match, the error is handled per the selected policy.
3. The first and second entities initialize their respective copies of the SKxIVr2r and SKxIVr2c to predetermined values. Next, the first entity derives a Secure Session Key (SKx) using the first random number and the chiplet's pre-shared secret. Next, the first entity calculates a MAC2 on the third random number using the derived SKx and initialized SKxIVr2c. Next, the first entity generates a write message containing first, second, and third random number (SKnonce, N1, and N2 respectively) and the calculated MAC2 (on the third random number or N2), sends the message to the second entity, and increments the SKxIVr2c.
4. Upon receipt of the write message sent in step 3, the second entity derives a Secure Session Key (SKx) using the first random number and the chiplet's pre-shared secret. Next the second entity calculates an expected MAC2e for the third random number (N2) and compares the expected MAC2e with the MAC2 contained in the write message. If the MAC values match, the process continues to the next step. If the MAC values do not match, the error is handled per the selected policy. The second entity also increments it's copy of the SKxIVr2c.
5. The first entity generates a read message requesting the second random number and sends the message to the second entity. Upon receipt of the read message, the second entity generates a read response message containing the second random number (N1) and calculates a MAC using the SKx derived in step 4 and the SKxIVc2r. The second entity sends the read response along with the calculated MAC to the first entity and increments the SKxIVc2r. Upon receipt of the read response, the first entity calculates an expected MACe for the read response message using the SKx and SKxIVr2r and compares the MACe to the MAC received with the read response. If the values match, the process continues to the next step. If the values do not match, the error is handled per the selected policy. The first entity also increments its copy of the SKxIVc2r.
6. After the integrity of the read response message is checked in step 5, the first entity compares the random number in read response with the second random number (N1) generated in step 1. If the values match, the chiplet is allowed into the system and allowed to continue booting. If the values do not match, the error is handled per the selected policy.

It may be noted that steps 2-6 are performed for each chiplet within the SiP.

In certain embodiments, one or more initialization vectors associated with a derived secure session key are initialized associated such that the same secure session key and initialization vector value pair is never used more than once per secure session.

In certain embodiments, a plurality of messages are sent between the first and second entities for a bus transaction.

Provided also are embodiments for integrity checking messages between two entities where operations are performed in which one or more secure session keys are derived using a secure hash of one or more pre-shared entity secrets and a cryptographically secure random number. One or more initialization vectors, associated with each session key, are initialized such that a secure session key/initialization vector value pair is never used more than once per session. Certain embodiments use the session keys and initialization vectors to generate a Message Authentication Code (MAC) for each message between entities. In certain embodiments, the session keys are also used for message encryption. The session keys may be generated using a SHA-3 hash. Various aspects of the present disclosure are described by narrative text,

flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

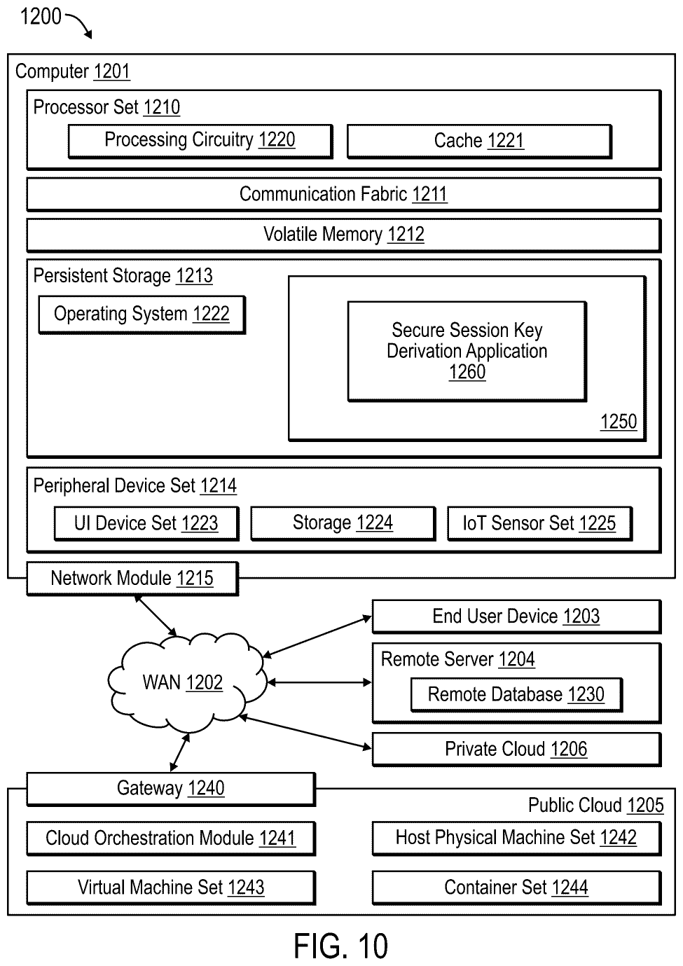

In FIG. 10, computing environment 1200 contains an example of an environment for the execution of at least some of the computer code (block 1250) involved in performing a secure session key derivation application 1260 that performs operations shown in FIGS. 1-9.

In addition to block 1250, computing environment 1200 includes, for example, computer 1201, wide area network (WAN) 1202, end user device (EUD) 1203, remote server 1204, public cloud 1205, and private cloud 1206. In this embodiment, computer 1201 includes processor set 1210 (including processing circuitry 1220 and cache 1221), communication fabric 1211, volatile memory 1212, persistent storage 1213 (including operating system 1222 and block 1250, as identified above), peripheral device set 1214 (including user interface (UI) device set 1223, storage 1224, and Internet of Things (IoT) sensor set 1225), and network module 1215. Remote server 1204 includes remote database 1230. Public cloud 1205 includes gateway 1240, cloud orchestration module 1241, host physical machine set 1242, virtual machine set 1243, and container set 1244.

COMPUTER 1201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1230. As is well understood in the art of computer technology, and depending upon the technology, performance of a computer-implemented method may be distributed among multiple computers and/or between multiple locations. On the other hand, in this presentation of computing environment 1200, detailed discussion is focused on a single computer, specifically computer 1201, to keep the presentation as simple as possible computer 1201 may be located in a cloud, even though it is not shown in a cloud in FIG. 12. On the other hand, computer 1201 is not required to be in a cloud except to any extent as may be affirmatively indicated.

PROCESSOR SET 1210 includes one, or more, computer processors of any type now known or to be developed in the future. Processing circuitry 1220 may be distributed over multiple packages, for example, multiple, coordinated integrated circuit chips. Processing circuitry 1220 may implement multiple processor threads and/or multiple processor cores. Cache 1221 is memory that is located in the processor chip package(s) and is typically used for data or code that should be available for rapid access by the threads or cores running on processor set 1210. Cache memories are typically organized into multiple levels depending upon relative proximity to the processing circuitry. Alternatively, some, or all, of the cache for the processor set may be located “off chip.” In some computing environments, processor set 1210 may be designed for working with qubits and performing quantum computing.

Computer readable program instructions are typically loaded onto computer 1201 to cause a series of operational steps to be performed by processor set 1210 of computer 1201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1221 and the other storage media discussed below. The program instructions, and associated data, are accessed by processor set 1210 to control and direct performance of the inventive methods. In computing environment 1200, at least some of the instructions for performing the inventive methods may be stored in block 1250 in persistent storage 1213.

COMMUNICATION FABRIC 1211 is the signal conduction path that allows the various components of computer 1201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1212 is any type of volatile memory now known or to be developed in the future. Examples include dynamic type random access memory (RAM) or static type RAM. Typically, volatile memory 1212 is characterized by random access, but this is not required unless affirmatively indicated. In computer 1201, the volatile memory 1212 is located in a single package and is internal to computer 1201, but, alternatively or additionally, the volatile memory may be distributed over multiple packages and/or located externally with respect to computer 1201.

PERSISTENT STORAGE 1213 is any form of non-volatile storage for computers that is now known or to be developed in the future. The non-volatility of this storage means that the stored data is maintained regardless of whether power is being supplied to computer 1201 and/or directly to persistent storage 1213. Persistent storage 1213 may be a read only memory (ROM), but typically at least a portion of the persistent storage allows writing of data, deletion of data and re-writing of data. Some familiar forms of persistent storage include magnetic disks and solid-state storage devices. Operating system 1222 may take several forms, such as various known proprietary operating systems or open-source Portable Operating System Interface-type operating systems that employ a kernel. The code included in block 1250 typically includes at least some of the computer code involved in performing the inventive methods.

PERIPHERAL DEVICE SET 1214 includes the set of peripheral devices of computer 1201. Data communication connections between the peripheral devices and the other components of computer 1201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1223 may include components such as a display screen, speaker, microphone, wearable devices (such as goggles and smart watches), keyboard, mouse, printer, touchpad, game controllers, and haptic devices. Storage 1224 is external storage, such as an external hard drive, or insertable storage, such as an SD card. Storage 1224 may be persistent and/or volatile. In some embodiments, storage 1224 may take the form of a quantum computing storage device for storing data in the form of qubits. In embodiments where computer 1201 is required to have a large amount of storage (for example, where computer 1201 locally stores and manages a large database) then this storage may be provided by peripheral storage devices designed for storing very large amounts of data, such as a storage area network (SAN) that is shared by multiple, geographically distributed computers. I/O T sensor set 1225 is made up of sensors that can be used in Internet of Things applications. For example, one sensor may be a thermometer and another sensor may be a motion detector.

NETWORK MODULE 1215 is the collection of computer software, hardware, and firmware that allows computer 1201 to communicate with other computers through WAN 1202. Network module 1215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1215 are performed on the same physical hardware device. In other embodiments (for example, embodiments that utilize software-defined networking (SDN)), the control functions and the forwarding functions of network module 1215 are performed on physically separate devices, such that the control functions manage several different network hardware devices. Computer readable program instructions for performing the inventive methods can typically be downloaded to computer 1201 from an external computer or external storage device through a network adapter card or network interface included in network module 1215.

WAN 1202 is any wide area network (for example, the internet) capable of communicating computer data over non-local distances by any technology for communicating computer data, now known or to be developed in the future. In some embodiments, the WAN 1202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1203 is any computer system that is used and controlled by an end user (for example, a customer of an enterprise that operates computer 1201), and may take any of the forms discussed above in connection with computer 1201. EUD 1203 typically receives helpful and useful data from the operations of computer 1201. For example, in a hypothetical case where computer 1201 is designed to provide a recommendation to an end user, this recommendation would typically be communicated from network module 1215 of computer 1201 through WAN 1202 to EUD 1203. In this way, EUD 1203 can display, or otherwise present, the recommendation to an end user. In some embodiments, EUD 1203 may be a client device, such as thin client, heavy client, mainframe computer, desktop computer and so on.

REMOTE SERVER 1204 is any computer system that serves at least some data and/or functionality to computer 1201. Remote server 1204 may be controlled and used by the same entity that operates computer 1201. Remote server 1204 represents the machine(s) that collect and store helpful and useful data for use by other computers, such as computer 1201. For example, in a hypothetical case where computer 1201 is designed and programmed to provide a recommendation based on historical data, then this historical data may be provided to computer 1201 from remote database 1230 of remote server 1204.

PUBLIC CLOUD 1205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1205 is performed by the computer hardware and/or software of cloud orchestration module 1241. The computing resources provided by public cloud 1205 are typically implemented by virtual computing environments that run on various computers making up the computers of host physical machine set 1242, which is the universe of physical computers in and/or available to public cloud 1205. The virtual computing environments (VCEs) typically take the form of virtual machines from virtual machine set 1243 and/or containers from container set 1244. It is understood that these VCEs may be stored as images and may be transferred among and between the various physical machine hosts, either as images or after instantiation of the VCE. Cloud orchestration module 1241 manages the transfer and storage of images, deploys new instantiations of VCEs and manages active instantiations of VCE deployments. Gateway 1240 is the collection of computer software, hardware, and firmware that allows public cloud 1205 to communicate through WAN 1202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1206 is similar to public cloud 1205, except that the computing resources are only available for use by a single enterprise. While private cloud 1206 is depicted as being in communication with WAN 1202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1205 and private cloud 1206 are both part of a larger hybrid cloud.

The letter designators, such as i, is used to designate a number of instances of an element and may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer-implemented method, comprising:
generating, by a first entity a secure session key and an initialization vector for integrity protecting messages transmitted between the first entity and a second entity, wherein the secure session key is generated based on a first random number and a pre-shared secret, wherein the first random number is shared via a transmission by the first entity of a first random number message to the second entity, and wherein the first entity receives the pre-shared secret of the second entity during provisioning; and
transmitting, by the first entity, a second random number to the second entity to initiate a process for authenticating the second entity, wherein the second entity is resource constrained relative to the first entity and is not configurable to generate the second random number.

2. The computer-implemented method of claim 1, the computer-implemented method further comprising:
transmitting, by the first entity, a read message to the second entity, wherein the read message includes a request that the second entity return the second random number to the first entity.

3. The computer-implemented method of claim 2, the computer-implemented method further comprising:
receiving, by the first entity from the second entity, a second random number message that is integrity protected using a Machine Authentication Code (MAC) that is calculated using the secure session key and the initialization vector, wherein the second random number message contains the second random number.

4. The computer-implemented method of claim 3, the computer-implemented method further comprising:
authenticating the second entity by the first entity via operations comprising:
confirming a validity of the second random number message based on the MAC; and
confirming that a number of the second random number message matches the second random number.

5. The computer-implemented method of claim 1, wherein the first entity is a Root-of-Trust (RoT) chiplet and the second entity is another chiplet in a System in a Package (SiP), and wherein the RoT has a capability to prevent the second entity from becoming operational.

6. The computer-implemented method of claim 1, wherein the second entity has lower processing power in comparison to the first entity, and wherein resources in the second entity are inadequate for executing a random number generator to generate the second random number.

7. The computer-implemented method of claim 1, wherein the second entity has lower processing power in comparison to the first entity, and wherein resources in the second entity are used for performing operations that do not include generation of the second random number via a random number generator.

8. The computer-implemented method of claim 1, wherein a third random number is used by the second entity to authenticate the first entity.

9. The computer-implemented method of claim 8, wherein both the first entity and the second entity mutually authenticate each other, wherein the second random number and the third random number can be transmitted simultaneously, and wherein the third random number is integrity protected.

10. The computer-implemented method of claim 9, wherein the mutual authentication is performed via: the third random number and a first MAC that allow the second entity to authenticate the first entity; and a second random number message and a second MAC that allow the first entity to authenticate the second entity.

11. A system, comprising:
a memory; and
a processor coupled to the memory, wherein the processor performs operations, the operations comprising:
generating, by a first entity a secure session key and an initialization vector for integrity protecting messages transmitted between the first entity and a second entity, wherein the secure session key is generated based on a first random number and a pre-shared secret, wherein the first random number is shared via a transmission by the first entity of a first random number message to the second entity, and wherein the first entity receives the pre-shared secret of the second entity during provisioning; and
transmitting, by the first entity, a second random number to the second entity to initiate a process for authenticating the second entity, wherein the second entity is resource constrained relative to the first entity and is not configurable to generate the second random number.

12. The system of claim 11, the operations further comprising:
transmitting, by the first entity, a read message to the second entity, wherein the read message includes a request that the second entity return the second random number to the first entity.

13. The system of claim 12, the operations further comprising:
receiving, by the first entity from the second entity, a second random number message that is integrity protected using a Machine Authentication Code (MAC) that is calculated using the secure session key and the initialization vector, wherein the second random number message contains the second random number.

14. The system of claim 13, the operations further comprising:
authenticating the second entity by the first entity via operations comprising:
confirming a validity of the second random number message based on the MAC; and
confirming that a number of the second random number message matches the second random number.

15. The system of claim 11, wherein the first entity is a Root-of-Trust (RoT) chiplet and the second entity is another chiplet in a System in a Package (SiP), and wherein the RoT has a capability to prevent the second entity from becoming operational in the system.

16. A computer program product comprising a computer readable storage medium having computer readable program code embodied therewith, the computer readable program code when executed is configured to perform operations, the operations comprising:
generating, by a first entity a secure session key and an initialization vector for integrity protecting messages transmitted between the first entity and a second entity, wherein the secure session key is generated based on a first random number and a pre-shared secret, wherein the first random number is shared via a transmission by the first entity of a first random number message to the second entity, and wherein the first entity receives the pre-shared secret of the second entity during provisioning; and
transmitting, by the first entity, a second random number to the second entity to initiate a process for authenticating the second entity, wherein the second entity is resource constrained relative to the first entity and is not configurable to generate the second random number.

17. The computer program product of claim 16, the operations further comprising:
transmitting, by the first entity, a read message to the second entity, wherein the read message includes a request that the second entity return the second random number to the first entity.

18. The computer program product of claim 17, the operations further comprising:
receiving, by the first entity from the second entity, a second random number message that is integrity protected using a Machine Authentication Code (MAC) that is calculated using the secure session key and the initialization vector, wherein the second random number message contains the second random number.

19. The computer program product of claim 18, the operations further comprising:
authenticating the second entity by the first entity via operations comprising:
confirming a validity of the second random number message based on the MAC; and
confirming that a number of the second random number message matches the second random number.

20. The computer program product of claim 16, wherein the first entity is a Root-of-Trust (RoT) chiplet and the second entity is another chiplet in a System in a Package (SiP), and wherein the RoT has a capability to prevent the second entity from becoming operational.
